(19) United States
(12) Patent Application Publication
(10) Pub. No.: US 2006/0248568 A1
(43) Pub. Date: Nov. 2, 2006

(54) Method and apparatus for providing cross-channel programming

(76) Inventors: Yuval Hamuz-Cohen, Tel Aviv (IL); Alon Barzilay, Tel Aviv (IL)

Correspondence Address: Mark M Friedman;Polkinghorn, 9003 Florin Way, Upper Marlboro, MD, 20772, US

(21) Appl. No.: 10/547,182

(22) PCT Filed: Feb. 18, 2004
(86) PCT No.: PCT/IL04/00153

§ 371 Date: Jun. 12, 2006

(30) Foreign Application Priority Data
Feb. 27, 2003 (IL) 154674

(51) Int. Cl. H04N 7/16; H04N 7/173

(52) U.S. Cl. 725/132; 725/140; 725/100

(57) ABSTRACT

Within a digital television environment comprising an operator, a distribution network, at least one set-top box, the set-top box is communicatively associated with at least one viewing device, an apparatus and method for using interactive applications within a digital television environment, the apparatus and method assisting in implementing cross channel programming such as used within typical channel, the apparatus and method comprising an interactive digital application loaded and executed within the at least one set-top box for registering viewers for timely channel change associated with pre-determined route built by centralized server.

### BACKGROUND OF THE INVENTION

1. FIELD OF THE INVENTION

The present invention relates to a method and apparatus for providing cross channel programming through digital television interactive applications, in general and to a method and apparatus enabling a viewer to view a television channel comprising of cross channel schedule programming from a plurality of other television channels, in particular.

2. BACKGROUND OF THE INVENTION

Multi-channel television consisting of a plurality of channels broadcasted over a distribution network such as satellite, cable or terrestrial is known in the art. Traditionally, a television channel is constructed by content experts, called programmers, bringing their experience and knowledge into selecting the best programs to build a channel based on the content available, time of broadcast, such as morning, prime-time or the like, target viewers such as kids, family, elderly or the like, genre and the like. In the multi-channel environment television service providers offer hundred and more channels, channels are increasingly becoming genre oriented. For example, service providers offer music channels, channels providing programming about nature, science or sports, news channels and the like. Service providers also target audience based on group age and interests. Channels are offered for kids or for the family, for teenagers or women. Such channels are rarely viewed continuously program after program at home. The variety of channels and program selection presents a decision problem to the viewer of selecting the next best suitable or entertaining program. The overwhelming number of television channels currently offered creates an entertainment overload that present a difficultly on the viewers' choice. Currently available mechanisms to enable viewers to select programs for viewing include an enhanced remote control for zapping and electronic or interactive programming guides showing on-screen information about the television schedule. Such tools require a typical viewer to “work” with the remote control constantly in order to search for the next program to the viewer's choice and do not assist in the viewer's need to valuate and find an entertaining selection of programs. Thus for example, U.S. Pat. No. 6,072,983 discloses a scheme for margin television schedule information received from multiple sources. The schedule information is displayed in a television schedule guide. A user can select a program by pointing to a particular program in the displayed schedule information. The system then carries out an automatic switching or tuning such that the required source device is input to the destination device, and a tuner is then tuned to the selected programs channel. U.S. Pat. No. 6,418,556 discloses an electronic program schedule system wherein a user control apparatus, such as a remote controller, is utilized by a viewer to choose user control commands and transmit signals in response to the data processor which receives the said signals in response to user control commands. A television receiver is used to display the television programs and television program schedule information. A video display generator receives video control commands from the data processor and program schedule information from the memory and displays a portion of the program schedule information in overlaying relationship with a television program appearing on a television channel in at least one mode of operation of the television programming guide.

The viewer's knowledge about the television programs is based on the information provided through the electronic program guide, which is severely limited. Viewers are not expected to posses the skills and knowledge of television programmers and content experts. In addition, audience guidance systems that suggest a next program based on the tracking history of viewing habit, limits the selection only to the channels and programs viewed previously. U.S. Pat. No. 6,486,920 discloses a program information storing section storing program information. A program information search section searches the program information stored in the program information storing section according to designated search conditions and produces personalized program information resulting from the search. A program guide display section displays a program guide including a personal programming schedule consisting of the resultant program information. Thus, the receiving apparatus allows users to display their personal programming preferences and selections according to their defined search conditions.

Some audience television guiding implementations, gather personalized information about viewers thus invading their privacy. It may also require the viewer to interact through the remote control or, in some implementations, require establishing a return channel to pass such information to a centralized management location, which creates a massive load over the return channel network due to the widespread of television.

Purchasing content, such as channels, programs or television shows is a major expenditure of a television service provider. Content is carefully searched and purchased in order to provide better and entertaining offerings. The task is risky and difficult to perform and, if not constantly renewed and renovated, may even lead to low viewer satisfaction and low competitive offering. Successful selection of programs from the various channels provides high level of entertainment offering to the viewer and better utilizes the investment in channels and programs made by the television service provider. Viewer or customer satisfaction leads to reduction in churn and thus reduces acquisition costs and lower operating costs since a typical business loses about half its customers' base every five years. On average, the cost of acquiring a new customer is five to ten times greater than the cost of retaining a current customer. Therefore, service providers seek to retain customers rather than acquiring new ones.

There is therefore a need for a method and apparatus for creating and offering new channels and new viewing experiences which will assist the viewer in making the selection which programs to view while preserving the viewer's satisfaction and television passive viewing experience.

### SUMMARY OF THE INVENTION

The present invention can be used within a digital television environment comprising an operator head end, a distribution network, at least one set-top box, the set-top box is communicatively associated with at least one viewing device.

One aspect of the present invention regards an apparatus for using interactive applications within a digital television environment, the apparatus comprising an interactive application loaded and executed within the at least one set-top box processing the interactive application, accesses to memory resources and the synchronizes channel changing according to the information retrieved from the memory resource.

The apparatus further comprises a cross-channel scheduler server located at the service provider center for building cross-channel programming route options loaded into the interactive applications.

Another aspect of the invention relates to producing dedicated television channel (or channels) that will fill in the time gaps between the end of one program to the beginning of another. The channel can include, for example, a narrator or a celebrity that will provide hosting between the programs.

### BRIEF DESCRIPTION OF THE DRAWINGS

The present invention will be understood and appreciated more fully from the following detailed description taken in conjunction with the drawings in which:

FIG. 1 is a schematic illustration of a typical section of a television programming guide in a digital television system environment, known in the art;

FIG. 2 is a schematic illustration of one route of viewing based on a typical section of television program schedule, in accordance with a preferred embodiment of the present invention;

FIG. 3 is a schematic illustration of multiple routes of viewing based on a typical section of television program schedule, in accordance with a preferred embodiment of the present invention;

FIG. 4 is a schematic illustration of a route with a time gap channel that fills programming time between route-selected programs, in accordance with a preferred embodiment of the present invention;

FIG. 5 is a schematic illustration of multiple routes with time gap channels that fills between route-selected programs, in accordance with a preferred embodiment of the present invention;

FIG. 6 is a schematic illustration of multiple routes sharing a single time gap channel, in accordance with a preferred embodiment of the present invention.

FIG. 7 is a schematic illustration of a typical digital television system and environment, in accordance with a preferred embodiment of the present invention;

FIG. 8 is a general overview of the programming scheduler apparatus of the present invention according to one preferred embodiment;

FIG. 9 is a flowchart showing an exemplary flow of the Join a Ride Application, in accordance with a preferred embodiment of the present invention;

FIG. 10 is a flowchart showing an exemplary flow of the Ride Application, in accordance with a preferred embodiment of the present invention;

FIG. 11 is an exemplary screen displays showing the on-screen selection process in a gap filler channel having more than one ride; FIG. 12 is a schematic illustration of the configuration of the channel rider server, in accordance with a preferred embodiment of the present invention.

### DETAILED DESCRIPTION OF THE INVENTION

### DEFINITIONS

For the purpose of this document the following terms shall have the meaning defined herein:
“Operator” is a service provider that provides digital television to viewers. The operator may broadcast digital television service by cables (CATV), satellite (DBS), terrestrial (DTT), Digital Subscriber Line (DSL) or another way of communication.
“STB” or “Set Top Box” is a device connected to a television set through which television signals are transmitted to a television screen, the STB comprise a central processing unit and a memory device. The STB may execute computer programs in association with the central processing unit and the memory device, the television screen being an output device. The viewer may interact with the STB to determine the channel viewed. The viewer may also interact with the STB through a remote control that facilitates television viewing and interactive services. Some STBs are capable of using a return channel to transfer information from an STB to the Operator's center. The return channel may comprise a telephone line, cable, DSL line, and the like.
“Applications” are computer programs executed by STBs and are also referred to as interactive applications. Typical Applications are executed by the STB and the output from the execution is typically displayed on the television screen. Such may include presenting text and graphics in an overlay on top of the video signal. The Applications are also typically programmed to receive selections from a remote control, monitor and control the presented channel and the like. To the viewer, the interactive content appears as graphical, text and informational images on the screen overlaying a video broadcast. The overlaying can be displayed in any shape, color, size or position. Often such images are opaque and cover the video broadcast in part, or transparent or semi-transparent. Specific reoccurring interactive content images include icons, banners, labels, menus images, and pictures. Application may be non-visual and handle events such as time measuring, channel change, pay-TV purchases and the like within a STB to grant Credits.
“Electronic Program Guide” or “EPG” is an Application designed for STBs that enables the viewer to view in graphic form information about the various programs distributed by the Operator. The viewer may use the remote control for selecting a channel and receive program information. The EPG may also be used in connection with pay-TV, Pay-Per-View, and can function as a parental rating control, booking a reminder on future programs, setup viewing preferences and the like.
“Digital Television” or “DTV” is the broadcasting of a digital television picture, sound, and data. The technique is based on standards such as digital video broadcasting (DVB) and the like.

Recent advances in digital television delivery technology enable delivery of television broadcast as well as software application to a viewing terminal such as the STB. This technology is often referred to as interactive digital television or interactive television. Interactive television enables the user to view a television (video and audio) feed combined with download and execution of software application by a STB processor. The software is able to access and use STB resources and, in particular, monitor and control the presented channel, handle remote control actions and the like. In many cases the STB is able to send information in the upstream direction to the digital television Operator's head end or to other aggregation center via dedicated return channel or via other means, such as a telephone line and the like. While the interactive television technology is available, only limited use is being made of this technology. Most interactive television operators would typically use this capability for providing an EPG to the viewer. In some instances rudimentary services such as weather forecast, voting, sports, statistics, and simple games are also offered.

The present invention provides a programming scheduler apparatus and method (PSA) using Applications in DTV or interactive television that applies hardware and software modules for providing cross channel programming. The cross channel programming creates a new television channel, which provides a viewing experience through creating viewing routes that pre-selects programs from multiple existing channels. The creation of a route is created at the Operator's head end. From the viewer's point of view, a program from one channel follows another program, from the same or other channel, comprising the new viewing channel. The PSA ability to offer new channels can affect the spectator's watching habits while keeping the passive nature of television watching, increase the Operator's Average Revenue Per User (ARPU) by offering to purchase the created channels, increase viewer satisfaction and thus reduce churn and create differentiation of services toward potential competitors (e.g. Satellite vs. Cable). Furthermore the PSA provides an apparatus for creating and selecting multiple routes experienced as channels, in parallel, and offers the viewers through re-use of already-broadcasted content a selection of routes to better suite their needs, offer guided viewing, theme routes (e.g. channel on New-York) and the like. The PSA of the present invention does not require from the viewer to search for programs or use the remote control in order to move from one channel to another, instead, a viewer is given the ability to join or leave a viewing route at any given time, similar to the experience of a regular channel. The PSA presents the programs to be viewed one after the other and is preferably implemented within the set top box (STB) at the premises of the subscriber through interactive application implementation.

Simply stated, the present invention provides a system that creates routes for viewing comprising a selection of programs from multiple existing channels broadcasted at the same time the route is viewed. The route also comprises a connecting sequences channel or a gap filler channel that fills the time gap between the programs making up the route. The connecting sequences can be video footage or a digital overlay or a digital stream of video or audio presenting or introducing the next program to be viewed. The gap filler channel also comprises Applications for controlling the STB to tune the viewer to programming offered by the Operator on other channels and introduced by the connecting sequences. The existing channels, viewed in a route include Applications for re-tuning the STB back to the gap filler channel for continued viewing of the next connecting sequence once a program on the existing channel has ended, thus the viewer experience is that of viewing a single channel. A selection of programs as described above is defined as a route, constructed by the Operator and offered to the viewer. The viewer selection of such a route will initiate a ride of the programs in the route. The ride is the STB actions in order to follow the route.

The PSA uses the notion of Ride for achieving its goals of creating new channels and viewing experience for affecting viewers watching habits of DTV. According to the present invention viewers can join a Ride, in several different ways. Once the viewer selects to join a Ride, the pre-selected route of programs is presented one after the other automatically. The viewer is able to leave a Ride in several different ways in any given time and return to a normal mode of watching any program in any channel. Since the PSA pre-selected route is based on existing scheduling of channels that may originate from different sources and may have no scheduling match of beginning and ending of programs, selected programs in a route may overlap, even partially, one another or may have a time gap between the end of one program to the beginning of the next. The present invention provides the ability to determine the route viewing in case of overlapping programs—either start viewing the next program at the end of the first program or at the beginning of the next program. In case of time gap, a dedicated channel can be added to offer audiovisual filler that can include live or pre-recorded hosting and guiding (such as media stars, celebrities or selected viewers), narrating, advertisements, interactive channel and the like.

According to the present invention both viewers and Operators benefit from the advantages of the present invention. The viewers will benefit by easing the decision-making and receiving valuated selection of programs better suit their needs (e.g. theme, guidance) which viewers will have to scout over the multi-channel offering, through zapping, or use of the EPG, to try to locate and select a program from the vast selection of programs. The Operators will benefit as well by offering new channels and new services of program selections made by a professional programmers, media stars or celebrities from the existing purchased and delivered content with little or no impact on distribution network bandwidth.

PSA helps the Operator to increase viewers' satisfaction and reduce chum which leads to reduced acquisition costs and lowered operating costs since a typical business loses about half its customers' base every five years. On average, the cost of acquiring a new customer is five to ten times greater than the cost of retaining a current customer. It is easier and cheaper for the Operator to retain a customer than acquire a new customer. In addition, PSA helps the Operator to create differentiation of services, such as in programs that may also be provided by the Operator's competitors, by adding new viewing routes thus creating new (and unique) channels.

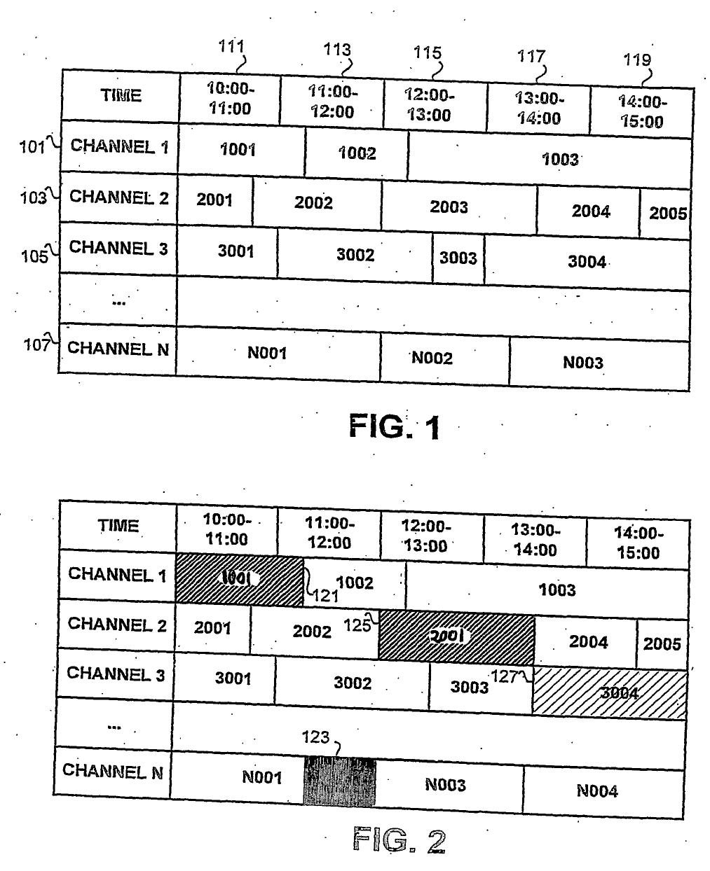

The apparatus and method of the present invention are operative in a DTV environment. The DTV environment comprise an Operator's head end distributing television channels and service using modulated and encoded digital signals along a distribution cable, radio frequencies or alternatively via satellite. The digital channels and signals are demodulated and decoded in the receiving STB and displayed on a display screen such as a television screen. Along with the television channel audio-video information, the digital signal may contain data for sub titles, EPG information, interactive application code and data and the like. Viewer's interacting with the STB may use a remote control device to control the EPG, change channels, view program information, purchase a pay-tv program, present television program schedule, and book a reminder to a future program and the like. Such a typical section of the television program schedule is shown in FIG. 1. The television program schedule is comprised of horizontal and vertical representation of television programs being broadcast through the DTV network along a time axis. For each of the listed multiple channels 101, 103, 105, 107 in the left column a series of television programs are uniquely marked according to the planned time of broadcast 111, 113, 115, 117, 119. As an example, for Channel 1, at 10:00, a program 1001 is scheduled to broadcast followed by program 1002 and so on. Likewise television programs are shown continuously on channels 2 (103), channel 3 (105) and so forth on N channels (107). Such schedule can be created for example by traffic and planning system. A person skilled in the art will appreciate that the channel numbers represent digital services such as defined in the ETSI EN 300 468 (DVB-SI) standard containing multiple PIDs of video, audio subtitle, applications and the like. The channel numbers shown are exemplary and other like or different number may be used.

Reference is now made to FIG. 2 that shows one route of viewing based on a typical section of television program schedule. The shown route is a compilation of programs distributed through various channels from the Operator's head end to subscribers. The shown route starts at 10:00 in program number 1001 (121) on channel 1. At the end of this program, at 12:20, program number N002 (123), from channel N is selected and follows this program at 12:00 program 2003 (125) from channel 2 is selected. Finally program 3004 (127) on channel 3 is selected. The selection of program in such route, one after the other, creates continues viewing of program after program similar to a regular channel.

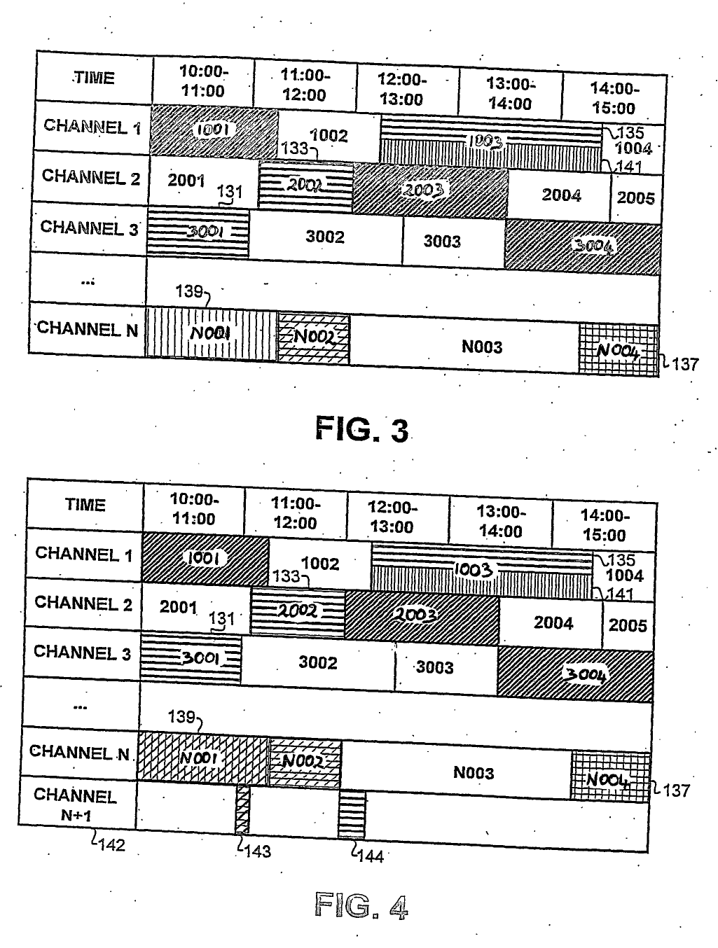

Reference is now made to FIG. 3 that shows multiple routes of viewing based on a typical section of television program schedule. The first route shown was described in association with FIG. 2. The second route shown includes program 3001 (131) on channel 3, program 2002 (133) on channel 2, program 1003 (135) on channel 1 and program N004 (137) on channel N. The second route includes program N001 (139) on channel N and program 1003 (141) on channel N. The routes, as shown in the drawing, may have a selection of the same programs for different routes, such as program 1003 (135, 141), whereas the rest of the route can have different selection of programs. Since the route is based on existing scheduling of channels that may originate from different sources, selected programs in a route may overlap, even partially, one another. For example, program 1003 (135) on channel 1 and program N004 (137) overlap, while a time gap exists between the end of program N001 (139) on channel N and the beginning of program 1003 (141) on channel 1. In case of overlapping programs in a route, the PSA operator may decide whether the first program 1003 (135) will be viewed until it ends and then move to the next program N004 (137) that already have started or move from the first program (135) before it ends but view the next program (137) from the its beginning.

Reference is now made to FIG. 4 that shows a route with a time gap channel that fills programming time between route-selected programs. In accordance with the present invention a new channel is generated to provide the user with the route viewing experience. The new dedicated channel can be produced and broadcasted to act as gap filler. The time gaps can be filled with connecting sequences which may comprise celebrity hosting or introduction of programs, commercials, or any other filler based on video or data broadcast to the viewer. In another example the gap filler can be a game broadcast to the viewer for a limited time, or a survey or a request to choose from a selection of upcoming programs. The time gap channel is a channel that is produced in order to maintain continues experience of a regular channel. At the end of program 3001 (131) on channel 3, the viewer will be watching the time gap channel N+1 (142) until the beginning of the next program in the route, program 2002 (133) on channel 2. Likewise when program 2002 (133) on channel 2 terminates, gap filler 144 on channel N+1 (142) will be distributed and viewed by the subscriber. When gap filler 144 terminates the viewer will be view program 1003 (135) on channel 1 and because no time gap is exists the viewer will view program N004 (137) on channel N immediately thereafter and there is no need to use the gap filler 144 on channel N+1 (142). The time gap channel may have a number as a regular channel (N+1) and may be an audiovisual channel, interactive channel or the like. The time gap channel enables to create new and original viewing experience such as hosted and guided program viewing. The channel can include, for example, a celebrity that will provide live or pre-recorded audiovisual filler of hosting between the programs that will guide through the viewing selection.

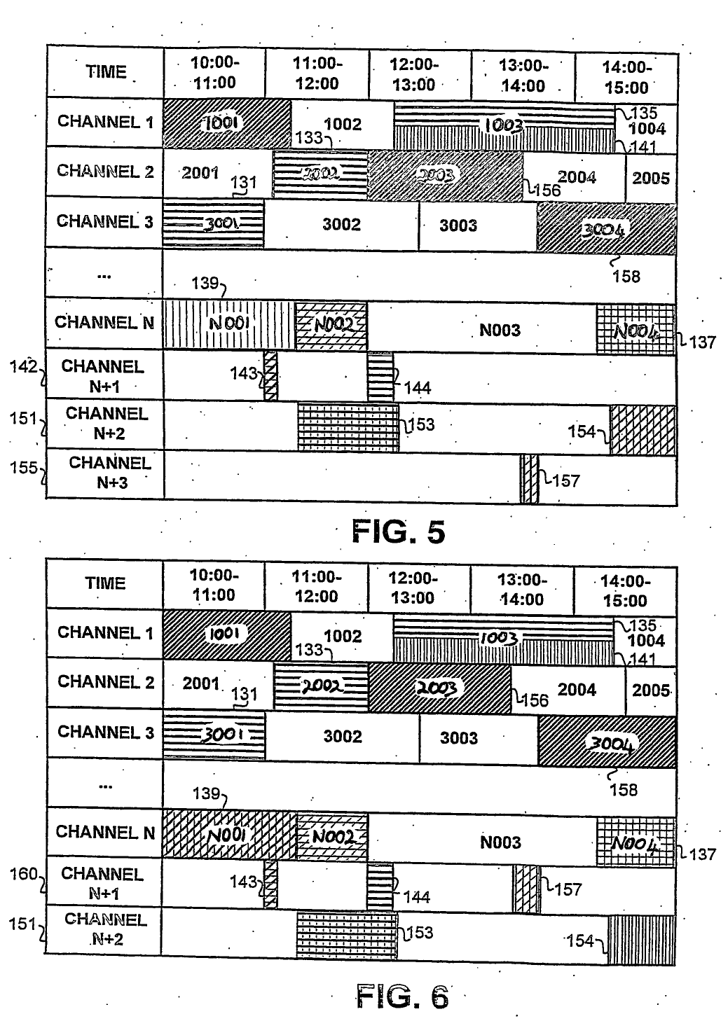

Reference is now made to FIG. 5 showing multiple routes with time gap channels that fills between route-selected programs. A time gap channel (142, 151, 155) is added to each of the routes in order to maintain continues experience of a regular channel in each route. As shown above, in a first route beginning with program 3001 (131) distributed on channel 3, at the end of program, the viewer will be watching the time gap channel N+1 (142) until the beginning of the next program in the route, program 2002 (133) on channel 2. In a second route, the viewer will be first watching program N001 (139) and then time gap channel N+2 (151) and connecting sequence 153 before the beginning of program 1003 (141) on channel 1. In a third route, only at the end of program 2003 (156), the viewer will be watching the time gap channel N+3 (155) until the beginning of the next program in the route, program 3004 (158) on channel 3. Different routes can point to the same program at any given time such as demonstrated in program 1003 (135, 141) on channel 1. Both the first and second routes will present this program at the same time after the gap fillers (connecting sequences) 144, 153 on channel N+2 (151) and channel N+3 (155). At the end of program 1003 (141) on channel 1 both routes can split again and point to different programs, such that the first route will now show program N004 (137) on channel N and the second route will now show gap filler or connecting sequence 154 on channel N+2 (151).

Reference is now made to FIG. 6 where multiple routes share a single time gap channel is shown. Instead of providing a single new channel for each route, a more limited number of new channels (or gap filler channels) can be provided. In the present example shown in association with FIG. 6 channel N+3 (155) of FIG. 5 is merged with channel N+1 (142) of FIG. 5. The merged channel N+1 (160) of FIG. 6 provides a single time gap channel for more than one route in order to maintain continues experience of a regular channel in each the first and the third route. In the first route at the end of program 3001 (131) on channel 3, the viewer will be watching the time gap filler or connecting sequence 143 on channel N+1 (160) until the beginning of the next program in the route, program 2002 (131) on channel 2. In the third route, after the program 2003 (156) on channel 2, the viewer will be watching the time gap filler or connecting sequence 157 on channel N+1 (160) before the beginning of program 3004 (158) on channel 3. In the example shown here the gap filler channel N+2 is maintained because gap fillers 144 and 153 conflict and cannot be distributed on the same channel. It will be appreciated that one gap filler channel may be used for more than two routes.

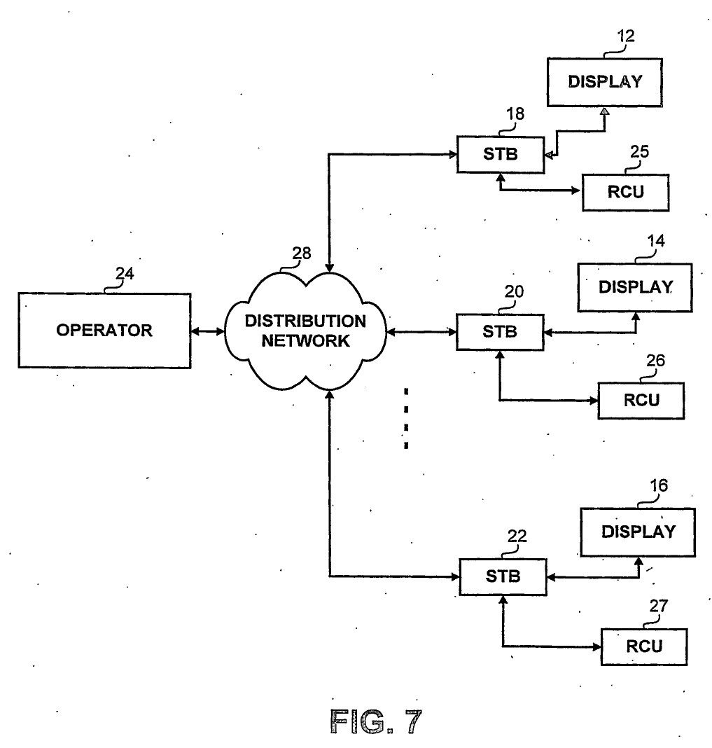

Reference is now made to FIG. 7 that shows a typical DTV system 10. DTV system 10 is used for broadcasting television channels and Applications. DTV system 10 is comprised of an Operator 24, a distribution network 28 and a plurality of STBs 18, 20 and 22. STBs 18, 20 and 22 are each connected to display apparatus 12, 14 and 16 respectively such as television screens and communicate with remote control units (RCU) 25, 26 and 27 respectively such as wireless (infrared) remote control. The illustration shown is simplified, but a person skilled in the art will appreciate that numerous Operators and STBs may be located within one PSA. Distribution network 28 is typically a cable television broadcasting system (CATV), a satellite broadcasting system (DBS) or a terrestrial broadcasting system (DTT) but can be also other communication networks such as DSL, the Internet, Cellular, LAN, WAN or like other networks having an analog or data signal transfer capability. DTV signals originating from Operator 24 are distributed through distribution network 28 to a plurality of STBs 18, 20, 22 which display the signals on screens 12,14,16 respectively. The STBs 18, 20, 22 can handle events originating from RCUs 25, 26, 27. Applications are downloaded to the STB, in parallel to television audio-visual signals. Once downloaded, an Application is executed by the STB central processing unit (not shown). The viewer can respond using keys in the RCU, which will communicate actions through the STB hardware to the Application. The television viewing is normally accomplished using the standard display device such as television set. In yet another embodiment, the interaction with the viewer may be accomplished using a personal computer designed to execute the Application and/or present the Application text and graphics over the PC or PC connected display device. Downloaded applications may be communicated to the PC for display or execution. The viewer may respond using input devices connected to a PC such as keyboard, mouse and the like, which will communicate the actions to STB.

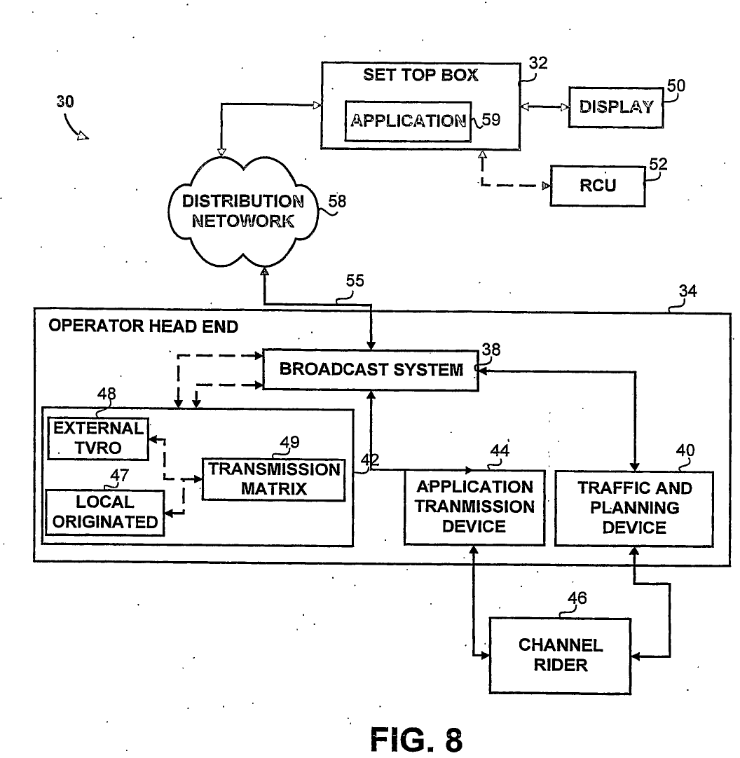

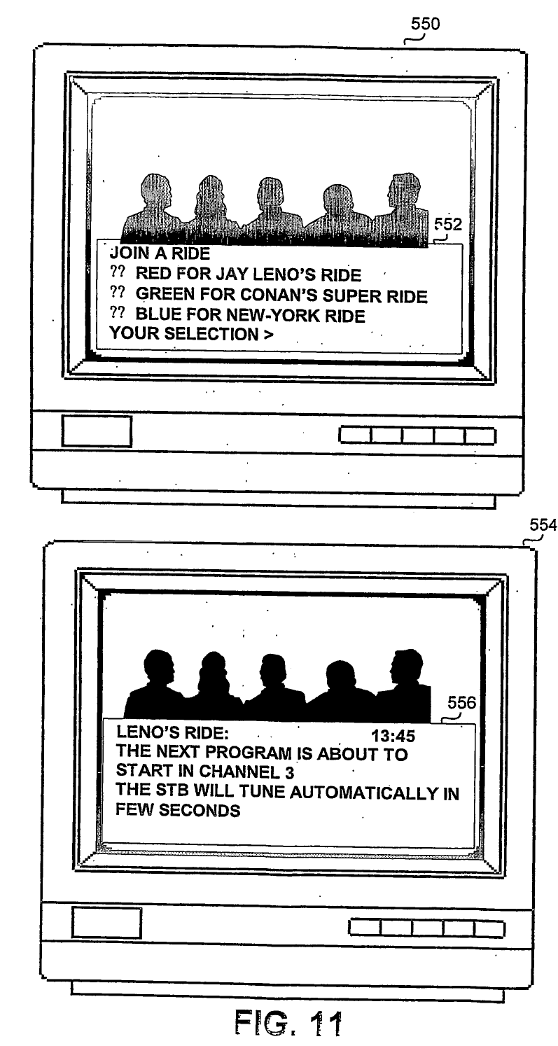

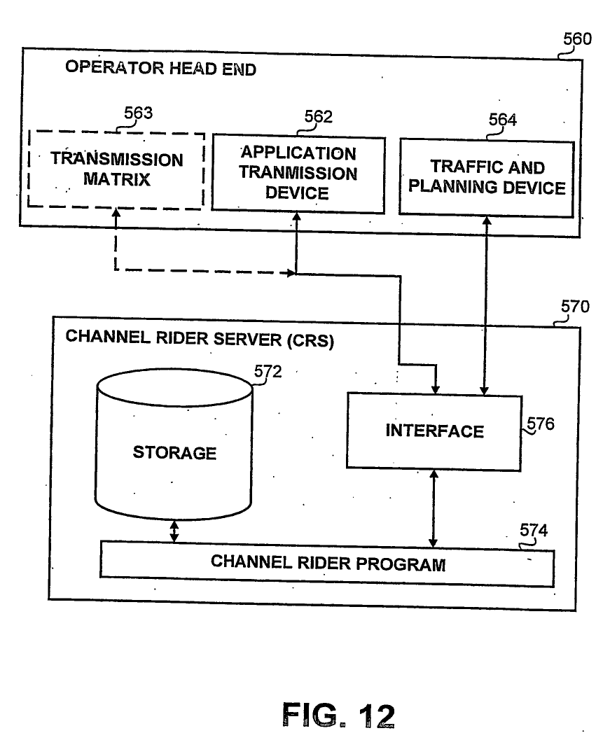

Referring now to FIG. 8 which shows a general overview of the a programming scheduler apparatus, according to one preferred embodiment of the present invention. PSA 30 includes an Operator head end 34 that is connected to STB 32 via a distribution network 58. STB 32 communicates with RCU 52 and sends television or audio/visual signals (such as UHF, Composite Video, RGB and the like) to display screen 50 that can be a television set or any other screen having the ability to present such signals. STB 32 uses display 50 to present Application graphics and data on the screen mixed together with the television signals such as can be viewed in association with FIG. 11 described below. In another embodiment, the Application graphics and data can be communicated from a STB 32 to a remote control device 52 comprising a display there within. In accordance with the present invention, the Operator head end 34 is connected to a channel rider server (CRS) 46. The channel rider server 46 can be positioned either within the Operator head end 34 or at a remote location linked via standard communication networks such as LAN, WAN, the Internet and the like networks. The scheduled information is passed to play out center 42 for controlling automation systems in local originated device 47 containing video server, video tape players and the like. The television program schedule information is also passed from traffic and planning device 40 to broadcast system 38 to supply the EPG with the program information. The channel rider server 46 in the preferred embodiment of the present invention receives scheduling information from traffic and planning device 40. The scheduling information contains channels and television program information such as channel number, program start time and the like. The channel rider server 46 enables route building through a graphical user interface (GUI) and creates an Application that contains the pre-determined route. According to the preferred embodiment of the present invention the connection between the viewer's STB 32 and the channel rider server 46 is performed through the Operator head end 34. Operator head end 34 includes a broadcast system 38, traffic and planning device 40, a Play out Center 42 and application transmission device 44. The Play out Center 42 includes a transmission matrix device 49, external TVRO device 48 and a local originated device 47.

The STB 32 can be a SkyB Digibox manufactured by Pace Digital Technology from Shipley West, Yorkshire, UK or like systems. The broadcast system 38 can be such a Television System 3000 manufactured by Tandberg Television from Southampton, UK or like systems. The application transmission device 44 can be an OpenStreamer manufactured by OpenTV from Mountain View, Calif., U.S.A. or like systems. The traffic and planning device 40 can be IBMS such as manufactured by Pilat-Media from Wembley, Middlesex, UK or like systems. The Play out center device 42 can be a Play out Center and Automation manufactured by Sony from Basingstoke, UK or like systems. The transmission matrix can be a HDSX5800 manufactured by Sony from Park Ridge, N.J., USA or like systems. The local originated device 47 are audiovisual channels originating from video tape player such as the J1/902 or video servers such as MAV70XGI manufactured by Sony from Park Ridge, N.J., USA or like systems. The external TVRO device 48 are audiovisual channels received from external broadcasters through satellite, fiber optics, cables or like systems. Such channel is Cable News Network LP (CNN) from Atlanta, Ga., USA.

In accordance with the present invention, the STB 32 is provided with a Channel Rider Application (CRA) 59. The CRA 59 is an Application program, which can be stored within the STB 32 by the manufacturer or downloaded by the operator head end 34 into the STB 32. The CRA 59 enables the viewer to: (a) join a Ride (b) automatically takes the viewer from one television program to the other according to the route made by the channel rider server 46 (c) leave a Ride and return to regular viewing. CRA 59 is loaded onto application transmission device 44. The application transmission device 44 stores and manages Applications. Applications are typically created using STB 32 native programming language software development tools and uploaded to application transmission device 44 that formats the application code and data into broadcasting format. According to the present embodiment the application transmission device 44 is a periodic cyclic transmission mechanism that manages the process of inserting the Application code and data into the broadcast stream, such as MPEG-2 ISO 13818-6: DSM-CC or the like. The application transmission device 44 can be any other suitable mechanism for downloading or broadcasting of Applications code and date to viewer's STBs. The application transmission device 44 sends stored Applications through broadcast system 38 and distribution network 58 to STBs located along the network. Though in FIG. 8 only one STB 32 is shown connected to Operator head end 34, according to the present embodiment a plurality of STBs can be connected to operator head end 34, all simultaneously operative to execute the CRA 59 of the present invention. Distribution network 58 can include but is not limited to broadband cable and hybrid fiber cable networks, satellite networks, terrestrial networks, high-speed telephone line services (such as DSL), wireless cable, wireless Digital Television system, and the like. The Operator controls the broadcasting content using play out center 42. Play out center 42 creates, monitors and controls television programs and channels that are delivered to STB 32 and displayed on screen 50. Local originated device 47 provides audiovisual channels originating from video tape players or video servers. Local originated device 47 outputs the channels signals to transmission matrix 49 inputs. One format used by local originated device 47 is the SDI format—Serial Digital Interface signal format. External TVRO device 48 produces audiovisual channels received from external broadcasters through satellite, such as satellite dish with a professional STB, fiber optics which typically originate from local channels, sports fields and the like, cables or like systems. External TVRO device 48 outputs the channels signals to transmission matrix 49 inputs. Transmission matrix 49 is typically a computer-controlled matrix enabling flexible connecting of input to outputs. The matrix typically enables to automatically switch redundant secondary input source in case primary input fails. The outputs are connected to broadcast system 38 that compresses, multiplexes, modulates and broadcasts the data. Broadcast system 38 can include a conditional access to encrypt the data stream such as VideoGuard provided by NDS, Staines Middlesex, UK in order to enable pay television services. According to one embodiment of the present invention, the compression of the data can be accomplished according to the MPEG-2 standard (ISO 13818), although other like standards can be used as well. Transmitted signal to STB 32 according to one embodiment of the present invention includes the following data: clock, services and channels information, multiple audio tracks, multiple video channels, conditional access information, EPG data, subtitling, teletext, control and management information and Application data. The transmission performed is synchronized using a centralized clock system distributed within all operator head end 34 components (not shown). Once all the relevant data has been compressed, multiplexed and modulated by broadcast system 38, it is transmitted via delivery mechanism 55 and distribution network 58 to STB 32. According to the present preferred embodiment STB 32 receives the transmitted signal and demodulates, demultiplexes, decrypts and decompresses said signal. STB 32 reconstructs the respective portions of the signal, which may comprise video, audio, Application, and other broadcast data. During the time the Application is broadcasted, STB 32 loads and executes the Application while the audio-video information—the normal television signal—is conveyed to the television set. STB 32 executes Applications using hardware and software components that are compliant with the Applications code and data within the STB 32. For example, if the Application is written in HTML code, then STB 32 will include an HTML interpreter, such as a browser or the like. Alternatively a unique client may interpret the Application for display and interaction with the viewer. The STB 32 includes a central processing unit and a memory device, which may be combined in a microcontroller or provided separately. Typically, the viewer actions such as pressing a key in the RCU 52 (remote control unit) are received by STB 32. The RCU 52 can be a standard wireless remote control supplied with the STB 32. The RCU 52 can include a pointing device such as a mouse device, a wireless keyboard or a like device which enables making a selection according to presented options. STB 32 receives commands from RCU 52 and passes the commands as events to be handled by the Application.

The present invention divides the cross channel route Application functionality into three:
(a) Join a Ride—The function offered to the viewer by STB 32 on Display 50 to actively start a Ride, optionally from plurality of Rides.
(b) Ride—The function to provide automatic channel changing according to a Route without viewer interaction (passive experience).
(c) Leave a Ride—The function offered to the viewer to actively stop the Ride function and return to regular television watching experience.

In the preferred embodiment of the present invention, an Application that provides the functionality to join a ride is broadcasted together with a gap filler channel.

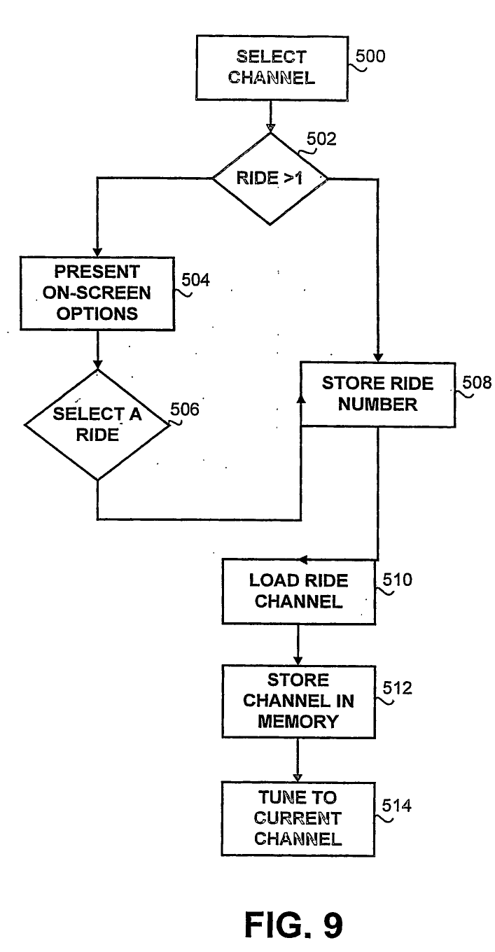

Reference is now made to FIG. 9 that shows the flow of the Join a Ride Application. In accordance with the present invention, in order to join a ride the viewer must tune the STB to a channel providing through download the Join a Ride Application. This channel is preferably the gap filler channel. In step 500 upon tuning to the gap filler channel, the Join a Ride Application, which is constantly broadcasted in this channel, is loaded and starts its execution. In step 502, if the gap filler channel enables more than one Ride, then the Application proceeds to step 504 and presents on-screen options and receives viewer's selection through the remote control unit. In step 506 the viewer selects a ride from the on-screen options presented to him. If in step 502 the gap filler channel enables only one ride the Application proceeds to step 508. In step 508 the Join a Ride Application stores in the STB memory the Ride number assigned uniquely by the channel rider server 46. The Application also stores the currently selected channel of the Ride and changes the STB channel to that channel. As a result the viewer tuning to a gap filler channel is automatically directed to the program now showing as part of the selected Ride. In the preferred embodiment of the present invention, an Application that provides the functionality to Ride through a pre-determined Route is broadcasted at the end of each television program.

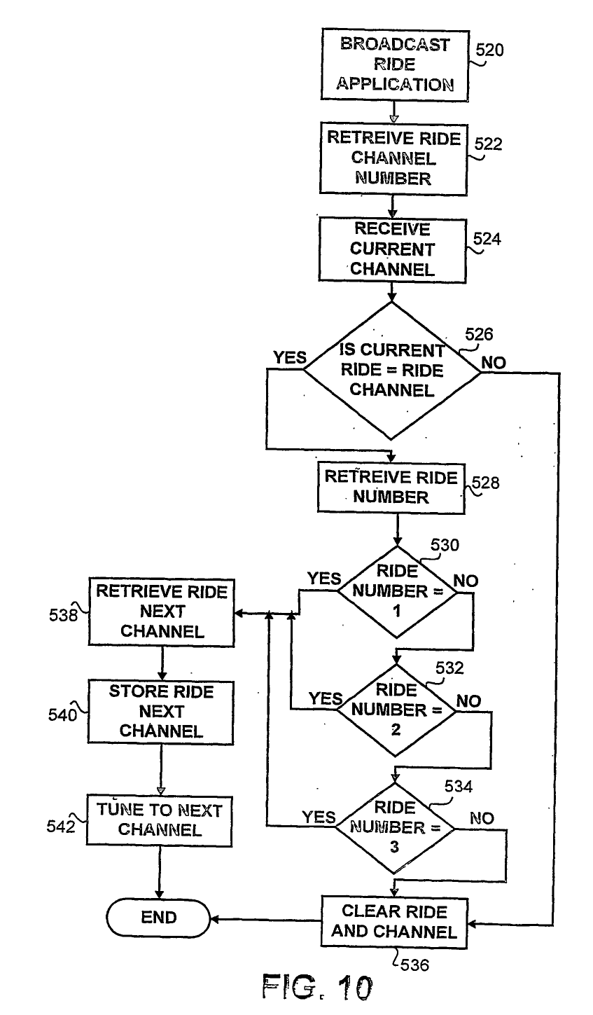

Reference is now made to FIG. 10 showing the flow of the Ride Application. As explained above once a viewer enters a gap filler channel, the Join a Ride Application directs the viewer's STB to the appropriate channel for watching the program now selected for the Ride watched. At the end of the television program the viewer's STB is still tuned to the channel where the program was broadcasted. Since the program now ended is a part of a Ride, in step 520 the CRS broadcasts the Ride Application, for a short period of time over the channel where the last program was broadcasted. The Ride Application is loaded and starts its execution. In step 522 the Application retrieves from the STB memory the Ride's current channel number and in step 524 the Application determines which channel is being viewed. In step 526 the Application checks if the STB is tuned to the Ride channel. If the STB is not tuned to the Ride channel than the Application in step 536 clears the Ride and channel number from the STB Memory. This means that the viewer has left the Ride and returned to regular channel viewing. If, on the other hand, the Ride's channel number is equal to the currently tuned channel, the Application in step 528 retrieves a list of Ride number and Next channel data pairs that determine the next channel and thus the next program of the Route according to the viewer's selected Ride. In steps 530, 532, 534 the Application checks the Ride Number selected. If the Ride number is not found in the list, the viewer has left the Ride, and in step 536 the Ride and channel number are deleted from the STB Memory and the STB returns to regular channel viewing. If the Ride number is found in steps 530, 532, 534, the Application in step 538 retrieves the next channel number associated with the Ride channel number. Next, in step 540 the Application stores the Ride next channel in the STB memory and in step 542 automatically tunes the STB to the next channel in the Route. The implementation of the Ride Application as described above, does not require the application to be broadcasted continuously thus reducing bandwidth usage and enabling other applications to be broadcasted before or after the Ride Application. Another benefit of the present invention is the Leave a Ride function that eliminates the need for dedicated application to perform this task.

According to the present embodiment the cross channel route is activated through the channel rider server 46 which defines the route based on existing television schedule and acts as a management system conveying the Application the Route information that instructs the STB to move or tune from one program to another at the defined time according to the Route. The Application complies with the STB's native programming language used such as HTML, C, Java, and others. In the preferred embodiment, the CRS 46 generates the Route information of the Ride Application. For each channel, from the information received from Traffic & Planning device 40, a table of scheduled programs with the end-time is built. An exemplary schedule in the form of a table is shown in table 1. As can be seen from the exemplary Table 1 for each channel program identification and program end-time is provided. For each gap filler channel the route information is provided.

TABLE 1

| | | | | | | | | Channel | Channel | Channel |
|---|---|---|---|---|---|---|---|---|---|---|
| Channel 1 | | Channel 2 | | Channel 3 | | Channel N | | N + 1 | N + 2 | N + 3 |
| Prog | Time | Prog | Time | Prog | Time | Prog | Time | Time | Time | Time |
| 1001 | 12:00 | 2001 | 11:50 | 3001 | 11:30 | N001 | 12:00 | 11:50 | 11:30 | |
| 1002 | 12:45 | 2002 | 13:20 | 3002 | 12:50 | N002 | 13:00 | | | |
| 1003 | 14:00 | 2003 | 13:45 | 3003 | 13:45 | N003 | 14:15 | | 14:15 | 13:20 |
| 1004 | 15:00 | 2004 | 15:05 | 3004 | 15:20 | N004 | 15:10 | | | |

From the scheduled programming Routes are built for each Ride. The Route can be built using the CRS 46 GUI. An exemplary list of programs and Routes for each Ride is described in Table 2.

TABLE 2

| | | | Next |
|---|---|---|---|
| | Current Channel | | Channel |
| Ride Number | Number | Time | Number |
| 1 | 1 | 12:00 | N |
| 1 | N | 13:00 | N + 3 |
| 1 | N + 3 | 13:20 | 2 |
| 1 | 2 | 13:45 | 3 |
| 2 | 3 | 11:30 | N + 1 |
| 2 | N + 1 | 11:50 | 2 |
| 2 | 2 | 13:20 | N |
| 2 | N | 14:15 | N |
| 3 | N + 2 | 11:30 | 3 |
| 3 | 3 | 12:50 | 1 |
| 3 | 1 | 14:00 | N + 2 |
| 3 | N + 2 | 14:15 | N |

The CRS 46 builds, according to the above information, data structures broadcasted with the Ride Application code. One exemplary data structure is shown in Table 3.

TABLE 3

| | | | | | | | | Channel | | Channel | | Channel | |
|---|---|---|---|---|---|---|---|---|---|---|---|---|---|
| Channel 1 | | Channel 2 | | Channel 3 | | Channel N | | N + 1 | | N + 2 | | N + 3 | |
| Time | Data | Time | Data | Time | Data | Time | Data | Time | Data | Time | Data | Time | Data |
| 12:00 | 1, N | 11:50 | —, — | 11:30 | 2, N + 1 | 12:00 | —, — | 11:50 | 2, 2 | 11:30 | 3, 3 | | |
| 12:45 | —, — | 13:20 | 2, N | 12:50 | 3, 1 | 13:00 | 1, N + 3 | | | | | | |
| 14:00 | 3, N + 2 | 13:45 | 1, 3 | 13:45 | —, — | 14:15 | 2, N | | | 14:15 | 3, N | 13:20 | 1, 2 |
| 15:00 | —, — | 15:05 | —, — | 15:20 | —, — | 15:10 | —, — | | | | | | |

The data in Table 3 can be represented as data pair structures expressed in pairs or R,N (Ride number, Next channel number). Additional parameters such as time and group/cluster can be provided and sent to the STB as well. The -,- signs provide null fields which means that there is no Route applied at that time for this program. The data can contain plurality of R,N pairs which exists when the same program is in the Route of more than one Ride. The Join a Ride Application uses the R,N pairs to start the Ride. The R,N pair of that application are updated every time the Ride is changing a channel, as can be seen in Table 2, for example. Where more than one ride is handled by a particular gap filler channel, the Join a Ride Application presents an option to the viewer to join a ride whereby the viewer is requested to make a selection by pressing a key in the remote control. The selection to be made is from the various rides available in the gap filler channel. The viewer may leave the ride by switching to another channel or by depressing a predetermined key over the remote control unit. STB 32, upon receiving the viewer response, passes the key event to the Join a Ride Application that reacts to the returned command and may display to the viewer a feedback of his choices. In one preferred embodiment of the present invention, upon receiving the command provided by the viewer, the Join a Ride Application manages a ride registration data or R,N pair locally in a memory within the STB 32, such as an HTML Cookie or the like. Next, the Ride Application accesses the registration data saved within STB 32 memory in order to determine the current ride the STB 32 is a member of.

FIG. 11 illustrates an exemplary screen displays showing the on-screen selection process in a gap filler channel having more than one ride. A Join a Ride and Ride Application displayed on screens 550 and 554. Screen display 550 shows a viewer with text and graphics 552. Text and graphics 552 is provided in an overlay manner by STB unit as shown in FIG. 8. Text and graphics 552 is an Application presenting the viewer with an offer to join a Ride from three Ride available for selection on the gap filler channel viewed. The viewer is invited to press a color key or the like in the remote control unit. As can be viewed in screen display 550 the Text and graphics 552 is covering only part of the screen and enables the viewer to continue watching the program broadcasted prior to the appearance of text and graphics 552. The graphic overlay created by the Application can be displayed in any shape, color, size or position. Screen display 554 presents a viewer with text and graphics 556. Text and graphics 556 provided by STB unit as shown in FIG. 8. Text and graphics 556 is an Application presenting the viewer with information on the current Ride the STB has joined and a message describing the next channel that the STB is about to tune automatically to, according to the Ride. The viewer does not need to use the RCU in order to the STB to tune to channel 3. Text and graphics 556 is optional and may be turned off by the viewer or by the Operator. As can be viewed in screen display 556 the text and graphics 556 is covering only part of the screen and enables the viewer to continue watching the program broadcasted prior to the appearance of text and graphics 556. The graphic overlay created by the Application can be displayed in any shape, color, size or position or not at all (no graphics or text). The Application can contain multiple text and graphics screens, other text phrases as well as audio, video and others that include direct messages to a viewer. The user may make his selection using a remote control unit, a selection device such as a mouse device, or via touch screen and the like.

FIG. 12 illustrates the configuration of the channel rider server 570 responsible for handling the cross channel Routes built by the Operator. The channel rider server 570 may be implemented as a stand-alone computer connected to the Operator head end through standard communication means such as LAN, WAN, the Internet and the like or as a software module in an existing system within the Operator head end such as the traffic and planning device 564. Channel rider server 570 includes a storage device 572, a channel rider program 574, an interface 576 as well as a processor device (not shown), a communication device (not shown), an operating system (not shown), an input and output devices (not shown). The Channel rider server 570 uses the main clock system distributed through interface 576 from Operator head end 560 such as Network Time Protocol in order to be in synchronization with the Operator head end 560 systems (not shown). The communication device provides the communication through a standard communication networks such as LAN, WAN, the Internet, and the like to the head end 560. The channel rider program 574 includes channel rider server applications and may also include a channel rider database that uses storage device 572 to store database information. As described in association with Tables 1-3 above, the Routes, Timing, and Channels information are stored in the storage device 572. The storage device 572 includes all data related to channels and program schedule, Routes, Rides available and the like that can be provided by the present invention. The channel rider program 574 retrieves television program schedule from traffic and planning device 564 from interface 576 and uploads, in a timely manner, to the application transmission device 562 the application code and data. The processing of channel rider program 574 includes, but is not limited to, define the channels that a Route can use for building a Ride, Build a Route, handle multiple Routes, Change or update a Route, Manage Join a Ride Application generation and Ride Application, set parameters and configuration.

In an alternative embodiment, an application is automatically adding events, according to a selected route, to the EPG booking mechanism. The EPG booking mechanism, uses the EPG to present on-screen the television programs schedule such as in a table format as shown in FIG. 1, typically for the next 24 hours or more, to enable the viewer to manually select and book a reminder to a future program using the remote control. The booking information is stored by the EPG within the STB memory, typically non-volotile RAM in a format such as: Service_ID (Channel), Event_ID (Program). A short time before the booked television program starts, the viewer receives a reminder in the form of EPG overlay banner that informs on the upcoming booked program. The viewer is then given an option to discard the reminder or to allow the mechanism to automatically tune to a channel when the booked program starts and the like. In this embodiment, the channel rider server 46 creates a list of one or more Service_ID (Channel) and Event_ID (Program) pairs according to the Route in the same format the EPG booking mechanism uses and conveys the list to the Join a Ride application. After the Join a Ride application is loaded to a STB in one of the ways described above it adds the list to the memory space allocated for the EPG booking. Since the EPG booking mechanism tunes from channel to channel according to the booking list, there is no need for a Ride Application. One skilled in the art can appreciate that the Leave a ride Application can be loaded similar to the Join a Ride application in order to erase the booking list or the viewer can use the EPG to manually erase the booking list or discard the reminders.

In another embodiment, the channel rider server 570 interfaces with the transmission matrix 563 in order to build a Route. In this embodiment, the channel rider server 570 operation is similar to the preferred embodiment except that instead of creating interactive Application code and data and loading such code and data for broadcast, the channel ride server 570 instructs the transmission matrix 563 to switch inputs to outputs according to the Route.

TABLE 4

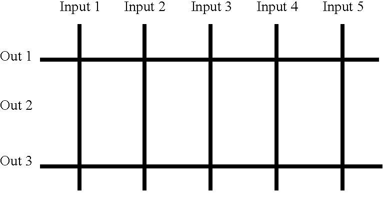

For example, if the transmission matrix 563 is build described in table 4 above, the channel rider server 570 can instruct the transmission matrix 563 to switch programs as provided in table 5 below.

TABLE 5

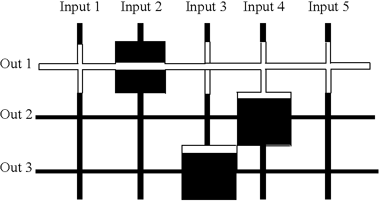

In the exemplary table 5 Output 1 is fed from Input 2, Output 2 is fed from Input 4 and Output 3 is fed from Input 3. Depending on the Route, at a destined time, the channel rider server 570 may instruct the transmission matrix 570 to change the connections as shown in table 6 below.

TABLE 6

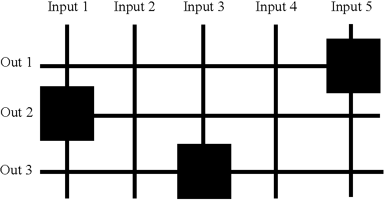

As shown in the exemplary table 6, Output 1 is fed by Input 5, Output 2 is fed with Input 1 while Output 3 remains unchanged with Input 3. In this way, the Outputs are channels built by the plurality of input channels according to the Route defined in the channel rider server 570.

In this embodiment, all the viewer must do is tune to the channel assigned to any of the outputs of the matrix and view the channel as any other channel. This embodiment requires additional channel to be broadcast, which creates duplicate transmission and double bandwidth consumption.

I/we claim:

1. Within a digital television environment comprising an operator head end, a distribution network, at least one set-top box, the set-top box is communicatively associated with at least one viewing device, a method for using interactive applications within a digital television environment, the method comprising the steps of:
tuning the at least one set top box to a predetermined channel for downloading and executing an interactive application for providing at least one route compilation for the predetermined channel;
storing the route number assigned to the at least one route in the at least one set top box;
loading and storing the channel number associated with the at least one route number stored in the at least one set top box; and
tuning to the channel number associated with the at least one route number for broadcasting the program associated with the at least one route.

2. The method as claimed in claim 1 further comprising the steps of:
broadcasting a program termination interactive application upon the completion of the program associated with the at least one route;
retrieving from the at least one set top box the at least one route and channel number stored there within and associated with the at least one route;
determining the channel currently viewed;
retrieving a next channel number and time of next viewing associated with the route number stored in the at least one set top box if the channel number currently viewed is identical to the channel number stored in the at least one set top box; and
tuning to the next channel number at the time of next viewing associated with the route number for broadcasting the program associated with the at least one route.

3. The method of claim 1 further comprising the steps of displaying on the viewing device a selection of routes to be selected from for viewing in association with the predetermined channel.

4. The method of claim 2 further comprising the step of clearing the at least one set top box memory if the channel number viewed is not the channel number stored in the at least one set top box.

5. The method of claim 2 further comprising the viewer selecting an at least one route from the selection of a plurality of route presented to him through the use of a remote control unit or a selection device.

6. The method of claim I further comprising the step of broadcasting a connecting sequence on the predetermined channel.

7. The method of claim 1 wherein the predetermined channel is a gap filler channel.

8. The method of claim 1 wherein the route number is assigned by a channel router server.

9. The method of claim 6 wherein the connecting sequence provides an introduction to the next program to be viewed in accordance with the next channel and viewing time.

10. The method of claim 9 wherein the connecting sequence length is the length between the time of ending of the program associated with the route and the time of next viewing associated with the route number stored in the at least one set top box.

11. The method of claim 1 further comprising the step of determining whether an overlapping programs exist within the at least one route.

12. The method of claim 11 wherein the step of determining further comprises the step of starting to view the next program at the end of the first program or at the beginning of the next program.

13. The method of claim 1 wherein the interactive application is loaded into an electronic programming guide application located in the at least one set top box.

14. The method of claim 13 the electronic programming guide application tuning from channel to channel according to a booking list.

15. Within a digital television environment comprising an operator head end, a distribution network, at least one set-top box, the set-top box is communicatively associated with at least one viewing device an apparatus for using interactive applications within a digital television environment, the apparatus comprising an interactive application loaded and executed within the at least one set-top box processing an interactive application for automatic channel changing synchronizing according to information downloaded from a cross channel scheduler server.

16. The apparatus of claim 15 further comprising a cross channel server for building cross-channel programming route options loaded into the interactive applications and sent.

17. The apparatus of claim 16 wherein the routes comprise routes based on existing television schedule and gaps in programming provided by connecting sequences distributed on a predetermined channel.

18. The apparatus of claim 15 further comprising a data storage, the data storage comprising of routes, each route comprising the associated channels and times of viewing to be downloaded to the at least one set top box.

19. The apparatus of claim 17 wherein the route and route Route information instructs the at least one set top box to tune from one program to another at a defined time according to the information predefined in the route.

20. The apparatus of claim 16 wherein the cross channel server generates route information of the interactive application to be downloaded to the at least one set top box.

21. The apparatus of claim 16 wherein the cross channel server comprises a channel rider program for retrieving television program schedule.

22. The apparatus of claim 15 wherein the interactive application is loaded into an electronic programming guide application located in the at least one set top box.

23. The method of claim 23 the electronic programming guide application tuning from channel to channel according to a booking list.

24. The apparatus of claim 15 further comprising an overlapping programs route handler for determining the route viewing in case of overlapping programs.

25. The apparatus of claim 24 wherein the overlapping programs route handler provides the option for either start viewing a next program at the end of the first program or at the beginning of the next program.
